(19) United States
(12) Patent Application Publication
(10) Pub. No.: US 2026/0179294 A1
(43) Pub. Date: Jun. 25, 2026

(54) USING A MODEL FOR VIDEO GENERATION AND CAMERA MOTION CONTROL

(71) Applicant: Meta Platforms, Inc., Menlo Park, CA (US)

(72) Inventors: Peter Vajda, Menlo Park, CA (US); Ching-Yao Chuang, Mountain View, CA (US)

(21) Appl. No.: 19/431,664

(22) Filed: Dec. 23, 2025

Related U.S. Application Data
(60) Provisional application No. 63/738,441, filed on Dec. 23, 2024.

(51) Int. Cl. G06T 13/00

(52) U.S. Cl. CPC G06T 13/00

(57) ABSTRACT

Systems and methods to facilitate determining camera motion for a video segment(s) are provided. The system may receive training data including a first plurality of video segments and a first plurality of classifications characterizing camera motion for a video segment of the first plurality of video segments. The system may receive a text string. The system may determine, from the text string, a first prompt associated with generating a video, based on the training data. The system may determine, from the text string, a second prompt associated with the camera motion for the video, based on the training data.

### CROSS-REFERENCE TO RELATED APPLICATIONS

The present application claims the benefit of U.S. Provisional Patent Application No. 63/738,441, filed on December 23, 2024, and titled “USING A MODEL FOR VIDEO GENERATION AND CAMERA MOTION CONTROL,” the disclosure of which is expressly incorporated by reference in its entirety.

### TECHNICAL FIELD

Aspects of the present disclosure are directed to video generation, and more particularly, to using a trained machine learning model to convert text to video and create camera motion control for the video.

### BACKGROUND

Video generation via text to video is controlled by prompts. When a machine learning model is trained on training data to generate text to generate video, the model may identify text within the video for generating the video.

### BRIEF SUMMARY

The present disclosure is directed to using a model (e.g., machine learning model (MLM)) such as a large language model (LLM), for example, for performing text to video media generation tasks and using the text to control the camera perspective for the video media generation. The MLM may be trained on data for generating video based upon text (e.g., text-based instructions), and also on data for camera motion based upon the text. In this regard, the MLM may output video with instructions for controlling the camera motion in the video.

In some examples, a model (e.g., a MLM) is trained on video segments and a label(s) that identifies camera motion depicted in the video segment. When the model receives text that includes both a request for video generation as well as a request for camera motion of the generated video, the model may identify/determine and differentiate between text corresponding to video generation and text corresponding to the desired camera motion for the generated video.

The exemplary aspects of the present disclosure may provide methods, apparatuses, systems, and computer program products to facilitate determining camera motion for images depicted in a video segment(s). For example, the methods, apparatuses, systems, and computer program products may facilitate, by a MLM, receipt of training data comprising a first plurality of video segments and a first plurality of classifications characterizing camera motion for a video segment of the first plurality of video segments. The methods, apparatuses, systems, and computer program products may further facilitate, by the model, receipt of a text string and based on the training data may determine, from the text string, a first prompt associated with generating a video and may determine, from the text string, a second prompt associated with the camera motion for the video.

In one example of the present disclosure, a method is provided. The method may implement a machine learning model. The method may include receiving training data comprising a first plurality of video segments and a first plurality of classifications characterizing camera motion for a video segment of the first plurality of video segments. The method may further include receiving a text string. The method may further include determining, from the text string, a first prompt associated with generating a video, based on the training data. The method may further include determining, from the text string, a second prompt associated with the camera motion for the video, based on the training data.

In another example of the present disclosure, an apparatus is provided. The apparatus may include one or more processors and a memory including computer program code instructions. The memory and computer program code instructions are configured to, with at least one of the processors, cause the apparatus to at least perform operations including receiving training data comprising a first plurality of video segments and a first plurality of classifications characterizing camera motion for a video segment of the first plurality of video segments. The memory and computer program code are also configured to, with the processor(s), cause the apparatus to receive a text string. The memory and computer program code are also configured to, with the processor(s), cause the apparatus to determine, from the text string, a first prompt associated with generating a video, based on the training data. The memory and computer program code are also configured to, with the processor(s), cause the apparatus to determine, from the text string, a second prompt associated with the camera motion for the video, based on the training data.

In yet another example of the present disclosure, a computer program product is provided. The computer program product may include at least one non-transitory computer-readable medium including computer-executable program code instructions stored therein. The computer-executable program code instructions may include program code instructions configured to receive training data comprising a first plurality of video segments and a first plurality of classifications characterizing camera motion for a video segment of the first plurality of video segments. The computer program product may further include program code instructions configured to receive a text string. The computer program product may further include program code instructions configured to determine, from the text string, a first prompt associated with generating a video, based on the training data. The computer program product may further include program code instructions configured to determine, from the text string, a second prompt associated with the camera motion for the video, based on the training data.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Certain features of the subject technology are set forth in the appended claims. However, for purpose of explanation, several examples of the subject technology are set forth in the following figures.

FIG. 1 illustrates an example of a system for training a MLM, in accordance with aspects of the present disclosure.

FIG. 2 illustrates an example of a classification of a text string for video generation and camera motion, in accordance with aspects of the present disclosure.

FIGS. 3A, 3B, and 3C illustrate an example of video generated from an MLM, in accordance with aspects of the present disclosure.

FIG. 4A and FIG. 4B illustrate an additional example of video generated from an MLM, in accordance with aspects of the present disclosure.

FIG. 5 illustrates an example flowchart showing a process for generating video from a model, in accordance with aspects of the present disclosure.

FIG. 6 illustrates an example of a machine learning framework including a video generation model and a training database, in accordance with one or more examples of the present disclosure.

FIG. 7 illustrates a block diagram of an example of a computing system, in accordance with one or more examples of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the present application. It is to be understood that the methods and systems described herein are not limited to specific methods, specific components, or to particular implementations.

As defined herein a “computer-readable storage medium,” which refers to a non- transitory, physical or tangible storage medium (e.g., volatile or non-volatile memory device), may be differentiated from a “computer-readable transmission medium,” which refers to an electromagnetic signal.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only, and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately, or in any sub-combination. Further, any reference to values stated in ranges includes each and every value within that range. Any documents cited herein are incorporated herein by reference in their entireties for any and all purposes.

It is to be understood that the methods and systems described herein are not limited to specific methods, specific components, or to particular implementations. It is also to be understood that the terminology used herein is for the purpose of describing particular embodiments only and is not intended to be limiting.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim. References in this description to “an example”, “one example”, or the like, may mean that the particular feature, function, or characteristic being described is included in at least one example of the present embodiments. Occurrences of such phrases in this specification do not necessarily all refer to the same example, nor are they necessarily mutually exclusive.

When an element is referred to herein as being "connected" or "coupled" to another element, it is to be understood that the elements can be directly connected to the other element or have intervening elements present between the elements. In contrast, when an element is referred to as being "directly connected" or "directly coupled" to another element, it should be understood that no intervening elements are present in the "direct" connection between the elements. However, the existence of a direct connection does not exclude other connections, in which intervening elements may be present.

The subject technology is directed to training an MLM with, for example, training pairs of prompts with text-to-video for video generation and camera motion control to make the video generation suitable for controlling the camera. When a model is trained on training data to generate text to generate video, the text itself does not include the camera motion in the training data. Based on this absence of such training data, the model is unable to generate a correct or proper camera motion. However, as described herein, the paired data can be selected with detection methods for large set of videos. Also, controlling motion with masking out part of the video can be trained with generated data where the mask is present with the control signals.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

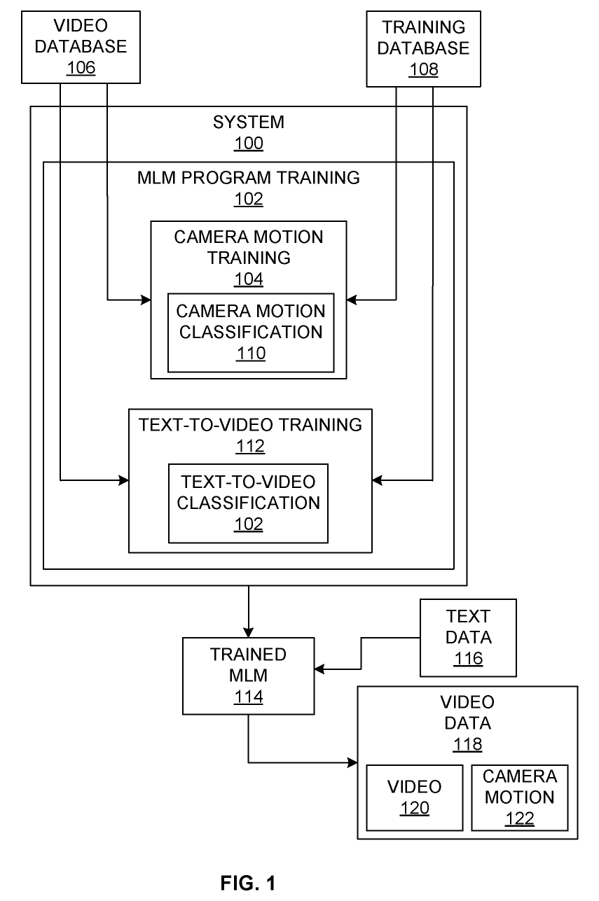

These and other embodiments are discussed below with reference to FIGS. 1, 2, 3A, 3B, 3C, 4A, 4B, 5, 6 and 7. However, those skilled in the art will readily appreciate that the detailed description given herein with respect to these Figures is for explanatory purposes only and should not be construed as limiting.

FIG. 1 illustrates an example of a system 100 for training a MLM, in accordance with aspects of the present disclosure. The system 100 may be utilized to train an MLM to generate video based on received text, such as a request(s) or prompt(s) to generate video based on the text. Moreover, the system 100 may be utilized to train the MLM to identify, from the received text, instructions for camera motion for the generated video.

The system 100 may include MLM program training 102 for training a MLM to generate video from text as well as camera motion (e.g., operation of camera including movement, zoom, etc.). The MLM program training 102 may include camera motion training 104. The system 100 may receive video from a video database 106 (e.g., containing video segments, motion images, etc.) and provide the video from the video database 106 to the camera motion training 104. The system 100 may receive training data from a training database 108 and provide the training data from the training database 108 to the camera motion training 104.

The camera motion training 104 may include camera motion classification 110. The camera motion classification 110 may be utilized to classify, or label, the camera motion in the video database 106, including multiple, different instance of camera motion within a video segment of the video database 106. This may include video segments with labeled camera motion. The training database 108 may provide training data in the form of various types of camera motions. For example, the camera motion classification 110 may use the training data from the training database 108 for classifying an instance(s) in the video database 106 in which the motion in the video database 106 pans to the left, right, up, or down. Further, the camera motion classification 110 may further use the training data from the training database 108 use the training data from the training database 108 for classifying an instance(s) in the video database 106 in which the motion trucks to the left, right, up, or down. Still further, the camera motion classification 110 may further use the training data from the training database 108 for classifying an instance(s) the video database 106 in which the motion pedestals to the left, right, up, or down. Still further yet, the camera motion classification 110 may use the training data from the training database 108 for classifying an instance(s) the video database 106 in which the motion zooms in or zooms out, thereby providing training for adjusting, or causing a change in, the perspective (e.g., viewing angle such as fly-over, point-of view) or field of view of a video segment from the video database 106. In this regard, each video segment from the video database 106 may be classified in terms of the types of camera motion(s) in the video segment. The foregoing types of classifications of camera motion are intended to be exemplary and non-limiting. Further, the camera motion classification 110 may use the training data from the training database 108 for classifying multiple, different instance(s) in the video database 106 in which the motion in the video database 106 pans, perspectives, field of views, zooms, trucks, dolly, tilt, roll, and/or pedestals.

Additionally, the MLM program training 102 may include text-to-video training 112. The text-to-video training 112 may be used to train an MLM to generate video based on received text. In this regard, the text-to-video training 112 may receive video segments from the video database 106. The text-to-video training 112 may further receiving training data from the training database 108 in the form of text-based data. The text-based data may characterize the video segment(s) received from the video database 106. For example, if the video database 106 includes a video segment of a person sitting on a bench and looking at an object, the training database 108 may provide text-based data to the text-to-video training 112 that describes a scene and/or identifies an action is occurring in the video (e.g., the person sitting on a bench and looking at an object). Accordingly, the text-to-video training 112 may be utilized to identify various objects from the training database 108 for use in generating video depicting images of the objects. The foregoing text-to-video scenario for the text-to-video training 112 is intended to be exemplary and non-limiting.

Also, the training data from the training database 108 may enable training the MLM program training 102 for creating masks associated with objects in a scene of a video. As a result, the text-to-video training 112 may to train an MLM to identify a request that includes a prompt to create a mask associated with an object(s). For instance, the mask may be aligned with, over, around, on top of otherwise arranged in relation to an object(s) or portion thereof (e.g., a face of a person). The object(s) may include (but are not limited to), a person(s), a vehicle(s), a structure(s) (e.g., a building) or other objects in a video frame(s). In this regard, an object with a mask may be targeted and the motion of the object may be tracked. This may cause the background or foreground of the video to move relative to the object(s), or vice versa, thus changing the perspective of the object(s).

Based on the MLM program training 102 (including the camera motion training 104 and the text-to-video training 112), the system 100 may train an MLM to generate, from a text-based input (e.g., text), video from text as well as generate the camera motion for the video. For example, a trained MLM 114 may be trained from the system 100 (e.g., from the text-to-video training 112) such that if the trained MLM 114 receives text data 116 that includes user prompts (e.g., instructions) or user requests for generating video, then the trained MLM 114 may identify the text from the text data 116 as a request to generate video data 118. Moreover, the trained MLM 114 may be trained from the system 100 (e.g., from the camera motion training 104) such that when the trained MLM 114 receives text data 116 that includes user prompts, the trained MLM 114 may further identify the text from the text data 116 as a request for camera motion (e.g., directing the camera in a particular manner(s)), which is further used to generate the video data 118. In this regard, the video data 118 generated from the trained MLM 114 may include video 120 and camera motion 122 for the video, as the trained MLM 114 may identify instructions for video generation as well as instructions for camera motion for the video generation. For clarity, it is noted that although the disclosure references camera motion, it is to be understood that the MLM 114 is trained to generate the video and may depict images in the video that mimic filming the images with such camera motion controls. For example, if a user prompt requests generation of a video and specifies a camera motion (e.g., pan left), the video is generated of a scene and may include a video frame in which the scene is depicted as if filmed by a camera that has panned left of a focal point of the scene.

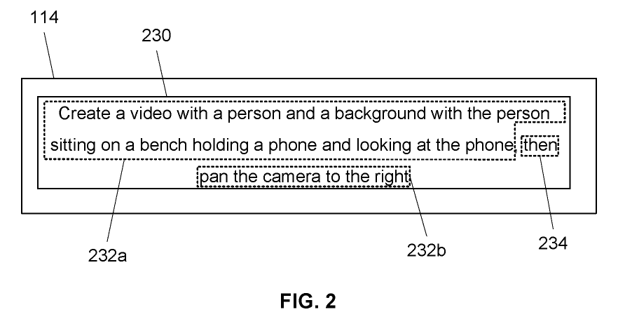

FIG. 2 illustrates an example of a classification of a text string 230 for video generation and camera motion, in accordance with aspects of the present disclosure. The trained MLM 114 (shown in FIG. 1) may receive and identify the text string 230 (e.g., corresponding to instructions from a user), allowing the trained MLM 114 to classify the text string 230 according to a prompt for video generation and according to instructions for camera motion. For example, the trained MLM 114 may process the text generate to a classification (e.g., text classification) for a portion 232a of the text string 230 associated with a prompt for video generation (e.g., “Create a video with a person and a background sitting on a bench with the person looking at a phone”). Additionally, the trained MLM 114 may generate a classification (e.g., text classification) for a portion 232b of the text string 230 associated with a prompt for camera motion (e.g., “pan the camera to the right”). An example of the video output from the trained MLM 114 is further shown and described below.

In one or more implementations, the trained MLM 114 is further trained on transition words to separate classifications. For example, the trained MLM 114 may be trained to identify and classify a transition word 234 (e.g., then) to separate the portion 232a from the portion 232b. The transition word 234 may characterize an order of events (e.g., instructions for video generation followed by camera motion). As non-limiting examples, the trained MLM 114 may be further trained to identify and classify conjunctions (e.g., and) and punctuation (e.g., comma, semicolon).

In some aspects, the MLM 114 may be configured to parse the text string 230 into tokens (e.g., a word, a phrase, or a sentence) such as portions 232a, 232b, and 234, for example. The MLM 114 may apply an attention mechanism (e.g., self-attention) which may identify more salient portions of the text string 230 according to attention weights determine during training of the MLM 114. The salient portions may be employed to determine an attention score and in turn a classification for various portions (e.g., 232a, 232b) of the text string 230.

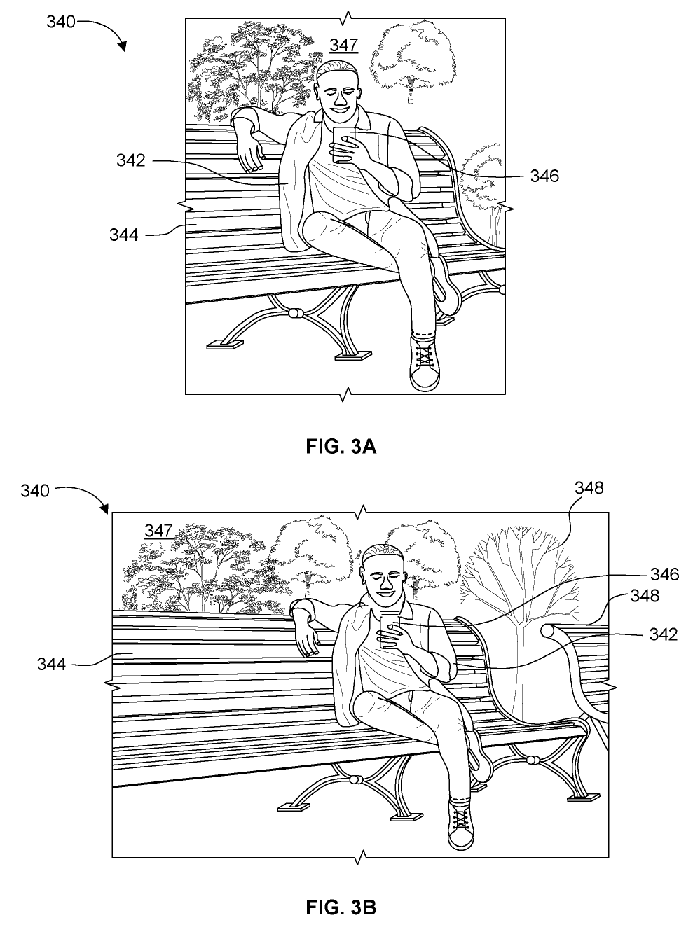

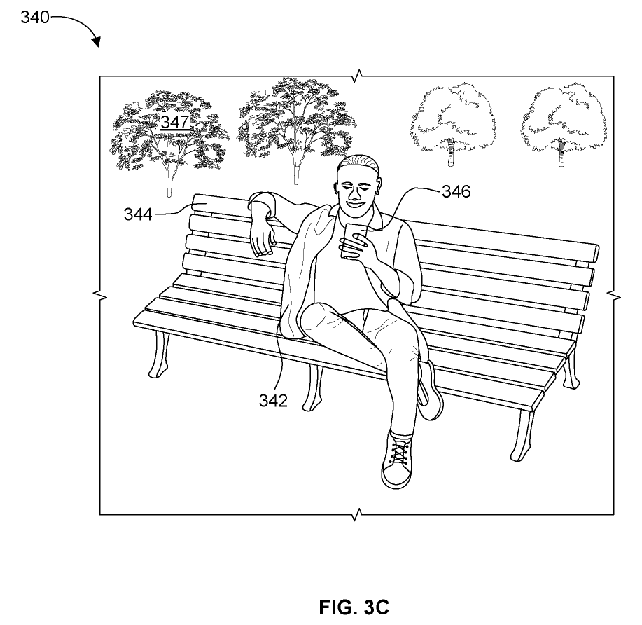

FIGS. 3A, 3B, and 3C illustrate an example of video 340 generated from an MLM (e.g., the trained MLM 114 shown and/or described in FIG. 1 and FIG. 2), in accordance with aspects of the present disclosure. Referring to FIG. 3A, the video 340 (e.g., motion images) includes a person 342 sitting on a bench 344 looking at an object 346 (e.g., phone). The video 340 may further include a background 347. The video 340 may correspond to a text string such as the text string 230 (shown in FIG. 2), and in particular the prompt from the portion 232a (shown in FIG. 2, referring to “Create a video with a person and a background sitting on a bench with the person looking at a phone”).

Referring to FIG. 3B, the video 340 pans to the right, corresponding to the text string 230 (shown in FIG. 2), and in particular the prompt from the portion 232b (shown in FIG. 2). As a result, the video 340 may generate additional content showing each of the person 342, the bench 344, and the object 346 as well as additional background including tree 348 and a second bench 349 to the right of the person 342 to convey that the video 340 is panning to the right.

Referring to FIG. 3C, the MLM adapts the video 340 using camera motion control to change the perspective relative to the person 342. For example, the MLM may adapt the video in response to receiving a text string (e.g., 230) requesting that a camera motion control such as “change the perspective relative to the person to a flyover,” for instance. As a result, the video 340 may generate additional content showing each of the person 342, the bench 344, and the object 346 as view from above to convey that the video 340 has the flyover perspective.

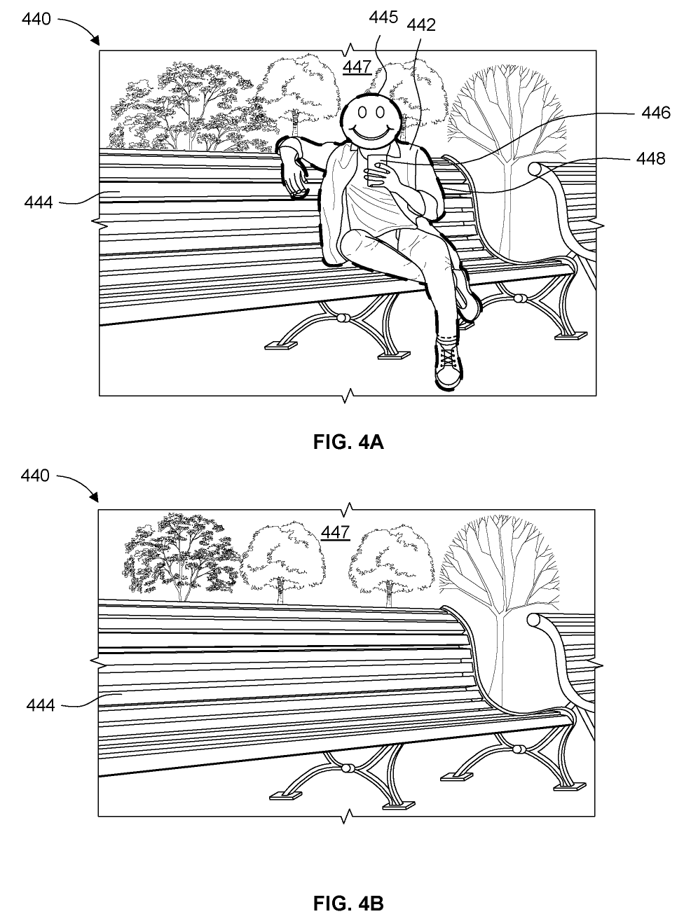

FIG. 4A and FIG. 4B illustrate an additional example of video 440 generated from an MLM (e.g., the trained MLM 114 shown and/or described in FIG. 1 and FIG. 2), in accordance with aspects of the present disclosure. Referring to FIG. 4A, the video 440 (e.g., motion images) includes a person 442 sitting on a bench 444 looking at an object 446 (e.g., phone). The video 440 may further include a background 447. The video 440 may correspond to the text string 230 (shown in FIG. 2), and in particular the prompt from the portion 232a (shown in FIG. 2). Additionally, the MLM may be trained to create a mask around persons (e.g., person 442) or objects (e.g., (bench 444) in a video (e.g., 440). For example, a mask 448 is created around the person 442. The mask 448 may be tightly arranged to outline the object as shown in the example mask 448. However, the present disclosure is not so limiting. Rather, the mask may be any size or shape. For instance, a mask 445 in the shape of a circular smiling face is applied to the head of the person (e.g., 342 shown in FIG. 3A).

In various aspects, the MLM may be trained to create a mask in response to a text prompt or request from the user. Additionally, or alternatively, when the MLM has generated a video in response to a user request (e.g., text string 230 of shown in FIG. 2), the MLM may be trained to create a mask (e.g., 448) around a person, an object, or an area in the video, in response to a selection of the object in the video using an input device such as a computer mouse, for instance.

When the mask 448 is created, the content within the mask 448 may be manipulated in various ways. For example, referring to FIG. 4B, the person 442 and the object 446 (both shown in FIG. 4A) are removed from the video 440, and the MLM may generate content that matches the bench 444. A text string (e.g., text string 230 shown in FIG. 2) may include an additional request with a prompt to remove the person 442 and the object 446, while the background 447 remains. Additionally, when the mask 448 is created, a request may be provided via text string to move the person 442 and/or the object 446, based on the camera motion, relative to the background 447. Alternatively, when the mask 448 is created, a request may be provided via text string to move or replace the background 447 relative to the person 442 and/or the object 446. For instance, the mask may be applied to the background 447 and MLM may be employed to change the background 447 to from trees shown in FIG. 4A to a beach in response to a text string from the user. Additional editing tasks may also be conducted relative to the mask. For example, when the mask is applied to the person 442, the MLM may change an article (e.g., accessories (clothing, shoes, glasses, or hats) or another characteristic (e.g., hair style, body shape or other physical features) associated with the person 448 in response to a text string from the user.

Additionally, or alternatively, the mask may be used for camera motion control. In some examples, the MLM may control camera motion relative to the object or person to which the mask (e.g., 448) is applied. For instance, where the mask is applied to the person 448, the MLM control the camera motion to change the perspective (e.g., fly-over or point of view) relative to the person.

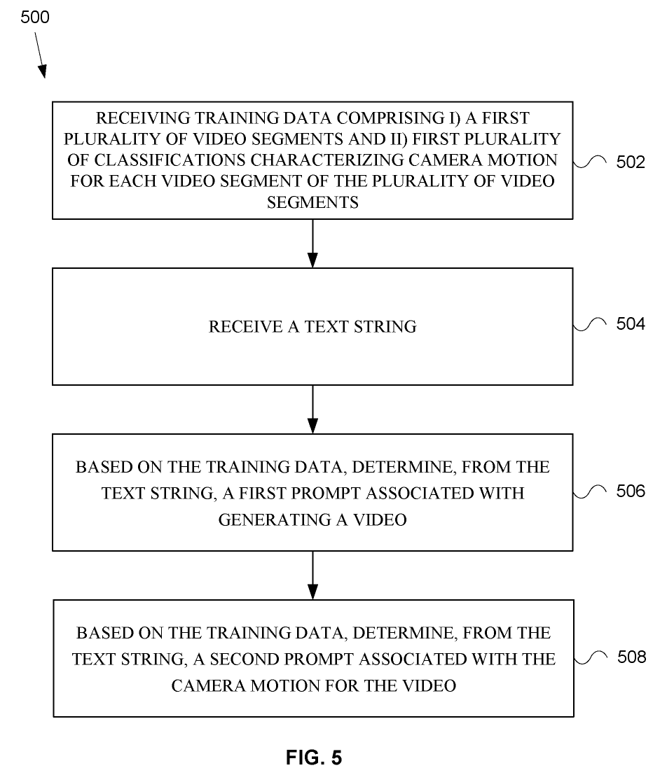

FIG. 5 illustrates an example flowchart showing a process 500 for generating video from a model (e.g., MLM), in accordance with aspects of the present disclosure. At operation 502, receiving training data comprising i) a first plurality of video segments and ii) a first plurality of classifications characterizing camera motion for each video segment of the plurality of video segments. At operation 504, receiving a text string. At operation 506, based on the training data, determining, from the text string, a first prompt associated with generating a video. At operation 508, based on the training data, determining, from the text string, a second prompt associated with the camera motion for the video.

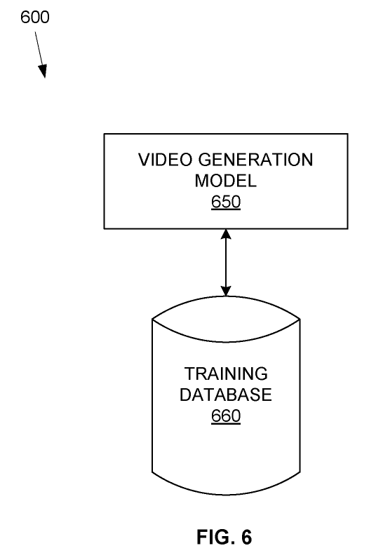

FIG. 6 illustrates an example of a machine learning framework 600 including a video generation model 650 and training database 660, in accordance with one or more examples of the present disclosure. The machine learning framework 600 may be hosted locally in a computing device or hosted remotely. The training database 660 may include several tasks (e.g., text-to-video, camera motion, masking etc.). Using the training database 660, the machine learning framework 600 may train the video generation model 650 to translate received text from one language to another, or vice versa. The video generation model 650 may be stored computing device. For example, the video generation model 650 may reside within an apparatus such as a computing system including a portable electronic device, a head-mounted display, a server, or the like.

The training database 660 may include a plurality of training datasets, which may include one or more video generation datasets, one or more text-to-video training sets, one or more camera motion training sets, and/or one or more masking training sets. Each of the one or more video generation datasets, the one or more text-to-video training sets, the one or more camera motion training sets, and/or one or more masking training sets may include labeled and/or unlabeled data. The labeled training datasets may be used, for example, to train a video generation model, such as the video generation model 650. The unlabeled training datasets may be used, for example, to validate the training. The training database 660 employed by the machine learning framework 600 may be fixed or updated periodically.

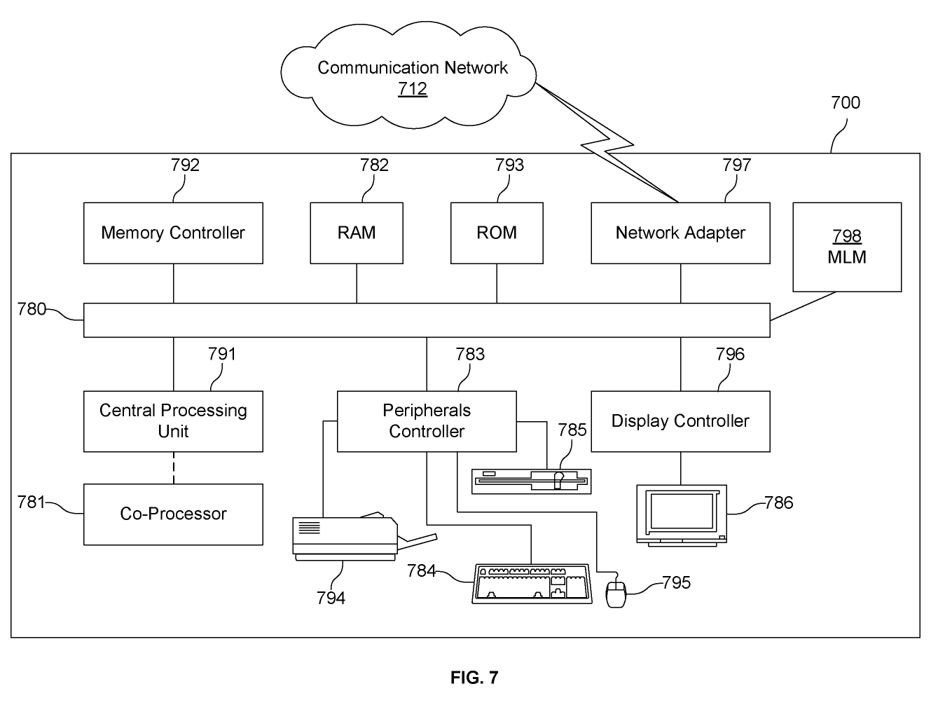

FIG. 7 illustrates a block diagram of an example of a computing system 700, in accordance with one or more examples of the present disclosure. The computing system 700 may include an MLM 798. The computing system 700 may comprise a computer or server and may be controlled primarily by computer readable instructions, which may be in the form of software, wherever, or by whatever means such software is stored or accessed. Such computer readable instructions may be executed within a processor, such as central processing unit 791, or CPU, to cause the computing system 700 to operate. In many workstations, servers, and personal computers, the central processing unit 791 may be implemented by a single-chip CPU called a microprocessor. In other machines, the central processing unit 791 may comprise multiple processors. Coprocessor 781 may be an optional processor, distinct from the CPU 791, that performs additional functions or assists CPU 791.

In operation, the central processing unit 791 fetches, decodes, and executes instructions, and transfers information to and from other resources via the computer’s main data-transfer path, the system bus 780. The system bus 780 may connect the components in computing system 700 and defines the medium for data exchange. The system bus 780 typically includes data lines for sending data, address lines for sending addresses, and control lines for sending interrupts and for operating the system bus. An example of such the system bus 780 is the Peripheral Component Interconnect (PCI) bus.

Memories coupled to the system bus 780 include RAM 782 and ROM 793. Such memories may include circuitry that allows information to be stored and retrieved. ROM 793 generally contain stored data that cannot easily be modified. Data stored in RAM 782 may be read or changed by the central processing unit 791 or other hardware devices. Access to RAM 782 and/or ROM 793 may be controlled by a memory controller 792. The memory controller 792 may provide an address translation function that translates virtual addresses into physical addresses as instructions are executed. The memory controller 792 may also provide a memory protection function that isolates processes within the system and isolates system processes from user processes. Thus, a program running in a first mode may access only memory mapped by its own process virtual address space; it cannot access memory within another process’s virtual address space unless memory sharing between the processes has been set up.

In addition, the computing system 700 may contain a peripherals controller 783 responsible for communicating instructions from the central processing unit 791 to peripherals, such as a printer 794, a keyboard 784, mouse 795, and a disk drive 785.

A display 786, which is controlled by a display controller 796, may be used to display visual output generated by computing system 700. Such visual output may include text, graphics, animated graphics, and video. The display 786 may also include, or be associated with, a user interface. The user interface may be capable of presenting one or more content items and/or capturing input of one or more user interactions associated with the user interface. The display 786 may be implemented with a cathode-ray tube (CRT)-based video display, a liquid-crystal display (LCD)-based flat-panel display, gas plasma-based flat-panel display, or a touch- panel. The display controller 796 includes electronic components required to generate a video signal that is sent to the display 786.

Further, the computing system 700 may contain communication circuitry, such as for example a network adaptor 797, that may be used to connect the computing system 700 to an external communications network, such as a communication network 712, to enable the computing system 700 to communicate with other nodes (e.g., electronic devices such as smartphones or tablet compute devices, servers, MR devices) connected to the network.

The MLM 798 may receive one or more requests for content from a device (e.g., an electronic device, server, MR device). In response to receipt of such a request(s) from the device, the MLM 798 may provide automated video generation of computer code to be presented to a user of the device, including text-to-video generation, camera motion, and masking. In some examples, the MLM 798 may be pre-trained, trained in real-time, and/or periodically trained with training data (e.g., from the training database 660 shown in FIG. 6) to determine text-to-video and camera motion based in part on receipt of the request(s) from the device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
by implementing a machine learning model:
receiving training data comprising a first plurality of video segments and a first plurality of classifications characterizing camera motion associated with a video segment of the first plurality of video segments;
receiving a text string;
determining, from the text string, a first prompt associated with generating a video, based on the training data; and
determining, from the text string, a second prompt associated with the camera motion for the video, based on the training data.

2. The method of claim 1, further comprising:
outputting the video based on the second prompt.

3. The method of claim 1, wherein:
the first prompt comprises a first request to generate the video with an object and a background; and
the second prompt comprises a second request to move the object, based on the camera motion, relative to the background.

4. The method of claim 1, wherein:
the first prompt comprises a first request to generate the video with an object and a background; and
the second prompt comprises a second request to move the background, based on the camera motion, relative to the object.

5. The method of claim 1, wherein:
the first prompt comprises a first request to generate the video with an object; and
the second prompt comprises a second request to zoom in or zoom out on the object.

6. The method of claim 1, wherein:
the first prompt comprises a first request to generate the video with an object; and
the second prompt comprises a second request to generate a mask around the object.

7. The method of claim 6, wherein:
the second prompt further comprises a third request to remove the object from the video.

8. The method of claim 1, wherein:
the second prompt causes a field of view of the video to change based on the camera motion.

9. An apparatus comprising:
one or more processors; and
at least one memory storing instructions, that when executed by the one or more processors, cause the one or more processors to:
receive training data comprising a first plurality of video segments and a first plurality of classifications characterizing camera motion associated with a video segment of the first plurality of video segments;
receive a text string;
determine, from the text string, a first prompt associated with generating a video, based on the training data; and
determine, from the text string, a second prompt associated with the camera motion for the video, based on the training data.

10. The apparatus of claim 9, wherein when the one or more processors further execute the instructions, the apparatus is configured to:
output the video based on the camera motion.

11. The apparatus of claim 9, wherein:
the first prompt comprises a first request to generate the video with an object and a background; and
the second prompt comprises a second request to move the object, based on the camera motion, relative to the background.

12. The apparatus of claim 9, wherein:
the first prompt comprises a first request to generate the video with an object and a background; and
the second prompt comprises a second request to move the background, based on the camera motion, relative to the object.

13. The apparatus of claim 9, wherein:
the first prompt comprises a first request to generate the video with an object; and
the second prompt comprises a second request to zoom in or zoom out on the object.

14. The apparatus of claim 9, wherein:
the first prompt comprises a first request to generate the video with an object; and
the second prompt comprises a second request to create a mask around the object.

15. The apparatus of claim 14, wherein:
the second prompt further comprises a third request to remove the object from the video.

16. The apparatus of claim 9, wherein:
the second prompt causes a field of view to change based on the camera motion.

17. A non-transitory computer-readable medium storing instructions that, when executed, cause:
receiving training data comprising a first plurality of video segments and a first plurality of classifications characterizing camera motion associated with a video segment of the first plurality of video segments;
receiving a text string;
determining, from the text string, a first prompt associated with generating a video, based on the training data; and
determining, from the text string, a second prompt associated with the camera motion for the video, based on the training data.

18. The non-transitory computer-readable medium of claim 17, wherein:
the first prompt comprises a first request to generate the video with an object and a background; and
the second prompt comprises a second request to move the object, based on the camera motion, relative to the background.

19. The non-transitory computer-readable medium of claim 17, wherein:
the first prompt comprises a first request to generate the video with an object; and
the second prompt comprises a second request to create a mask around the object.

20. The non-transitory computer-readable medium of claim 19, wherein:
the second prompt further comprises a third request to remove the object from the video.
